(19) United States
(12) Patent Application Publication
(10) Pub. No.: US 2014/0229416 A1
(43) Pub. Date: Aug. 14, 2014

(54) ELECTRONIC APPARATUS AND METHOD OF RECOMMENDING CONTENTS TO MEMBERS OF A SOCIAL NETWORK

(71) Applicant: SAMSUNG ELECTRONICS CO., LTD., Suwon-si (KR)

(72) Inventors: Sang-min BAE, Seoul (KR); O-kyun KOWN, Seoul (KR)

(73) Assignee: SAMSUNG ELECTRONICS CO., LTD., Suwon-si (KR)

(21) Appl. No.: 14/172,127

(22) Filed: Feb. 4, 2014

(30) Foreign Application Priority Data
Feb. 13, 2013 (KR) 10-2013-0015396

(51) Int. Cl. G06N 5/02

(52) U.S. Cl. CPC G06N 5/02
USPC 706/46

(57) ABSTRACT

An electronic apparatus and a method of recommending content are provided. The method of recommending content of an electronic apparatus includes determining recommendation subjects for a content based on preference information of social network members in response to a preset command being input while the content is being provided, displaying a list including the recommendation subjects of the content, and recommending the content related to a selected recommendation subject in response to a selection of at least one of the recommendation subjects included in the displayed list.

### CROSS-REFERENCE TO RELATED APPLICATION

This application claims priority from Korean Patent Application No. 10-2013-0015396, filed on Feb. 13, 2013, in the Korean Intellectual Property Office, the disclosure of which is incorporated herein by reference, in its entirety.

### BACKGROUND

1. Field

Apparatuses and methods consistent with exemplary embodiments relate to an electronic apparatus and a method of recommending a content. More particularly, the exemplary embodiments relate to an electronic apparatus and method of recommending a content to members of a social network service.

2. Description of the Related Art

With the recent increase in user requests for contents, content users mainly access contents recommended by others or recommended by content providers, rather than accessing general contents.

With respect to methods of recommending contents, there is a method of analyzing propensities of individuals (for example, contents relating to use of electronic apparatuses, search contents, and the like), and recommending contents based on personal preference. Alternatively, there exists a method of posting a corresponding content on a web page as a recommendation of content when another person presses a preference button for the specific content, and allowing the users viewing the web page to confirm the recommendation content.

However, since the former method recommends the content based on information obtained from a past pattern of behavior of a corresponding user, there no limit to using contents recommended by others. Further, the latter method uses the content which is unilaterally recommended by others. However, there is no limit not to recommending contents which reflect the personal preferences of a user.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments are to provide an electronic apparatus and method capable of allowing a user to recommend a content by considering preferences of other members of a social network service, through selection of recommendation subjects for the content based on preference information of social network members.

According to an aspect of an exemplary embodiment, there is provided a method of recommending a content is provided. The method may include: determining recommendation subjects for a content based on preference information of social network members when a preset command is input while the content is being provided; displaying a list including the recommended subjects of the content; and recommending the content related to a selected recommendation subject in response to at least one of the recommendation subjects included in the list being selected.

The determining may include requesting to a social network server the preference information for the social network members; and determining the recommendation subjects for the content extracted based on the preference information of the social network members when the preference information of the social network members is received from the social network server.

The recommending may include transmitting information for the selected recommendation subject and information for the content to the social network server so that the social network server provides the information for the content of the selected recommendation subject.

The preference information of the social network members may be directly input by the social network members or may be determined by the social network server based on information related to the social network members which is stored in the social network server.

In response to a pre-designated application being executed by the selected recommendation subject, the social network server may provide the information for the content to the selected recommendation subject.

The displaying may include displaying the list by aligning the recommendation subjects of the list in descending order of with respect to a degree of interest for the content.

The method may further include recommending the content to an input member when the member not included in the list, is individually input.

The recommending may include recommending the content to all the recommendation subjects included in the list when a specific icon included in the list is selected.

According to another aspect of an exemplary embodiment, there is provided an electronic apparatus. The electronic apparatus may include: a communicator configured to communicate with an external apparatus; an input configured to receive a user command; a display; and a controller configured to determine recommendation subjects for a content based on preference information of social network members in response to a preset command being input through the input while the content is being provided, control the display to display a list including the recommendation subjects for the content, and control the communicator to recommend the content to a selected recommendation subject in response to at least one of the recommendation subjects included in the list being selected through the input.

The communicator may be configured to communicate with a social network server. The controller may request the preference information for the social network members to the social network server, and may be configured to determine the recommendation subjects for the content extracted based on the preference information of the social network members in response to the preference information of the social network members being received from the social network server through the communicator.

The controller may be configured to control the communicator to transmit information for the selected recommendation subject and information related to the content to the social network server so that the social network server provides the information related to the content to the selected recommendation subject.

The preference information of the social network members may be directly input by the social network members or may be determined by the social network server based on usage information of the social network members which is stored in the social network server.

The social network server may provide the information related to the content to the selected recommendation subject in response to a pre-designated application being executed by the selected recommendation subject.

The controller may be configured to control the display in order to display the list by aligning the recommendation subjects of the list in descending order of a degree of interest for the content.

The controller may be configured to control the communicator to recommend the content to an input member, when the member not included in the list, is individually input through the input.

The controller may be configured to control the communicator to recommend the content to all the recommendation subjects included in the list in response to a specific icon included in the list being selected through the input.

An aspect of an exemplary embodiment may further provide an electronic apparatus, including: a communicator configured to perform communication with an external apparatus; and a controller configured to determine recommendation subjects for a content based on preference information of social network members, control a display in order to display a list which includes the recommendation subjects related to the content, and control a communicator to recommend the content related to a selected recommendation subject.

The electronic apparatus may further include an input configured to receive a user command and a display.

The controller may determine recommendation subjects for a content in response to a preset command being input while the content is being provided.

The controller may control the communicator to recommend the content in response to at least one of the recommendation subjects included in the list being selected through the input.

The communicator may be configured to perform communication with a server of a social network, wherein the controller requests the preference information of the social network members from the social network server, and determines the recommendation subjects for the content extracted based on the preference information of the social network members in response to the preference information of the social network members being received through the communicator from the social network server.

In addition, the controller may be configured to control the communicator to transmit to the social network server information related to the selected recommendation subject and information related to the content so that the social network server provides to the selected recommendation subject the information related to the content.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a view which illustrates a content recommendation system, according to an exemplary embodiment;

FIG. 2 is a view schematically which illustrates a configuration of an electronic apparatus, according to an exemplary embodiment;

FIG. 3 is a detailed block diagram which illustrates a configuration of an electronic apparatus, according to an exemplary embodiment;

FIGS. 4 to 6 are views which illustrates user interfaces (UIs) for content recommendation, according to an exemplary embodiment;

FIG. 7 is a flowchart which illustrates a method of recommending a content of an electronic apparatus, according to an exemplary embodiment; and

FIG. 8 is a sequence diagram which illustrates a method of recommending a content of a content recommendation system, according to an exemplary embodiment.

### DETAILED DESCRIPTION OF THE EXEMPLARY EMBODIMENTS

Hereinafter, exemplary embodiments will be described in more detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

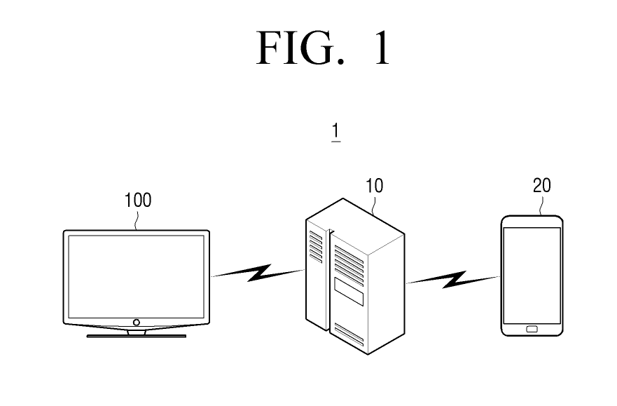

FIG. 1 is view which illustrates a content recommendation system 1 according to an exemplary embodiment. As illustrated in FIG. 1, the content recommendation system 1 includes an electronic apparatus 100 used by a user who is to recommend a content, a social network server 10, and other electronic apparatus 20 used by a social network member. The electronic apparatus 100 may be a smart television (TV) or a smart phone, but it is merely an exemplary embodiment, and the electronic apparatus 100 may be implemented with various electronic apparatuses such as a desktop personal computer (PC), a laptop PC, a tablet PC and a personal digital assistant (PDA).

The social network server 10 collects preference information related social network members. Specifically, the social network server 10 may receive and store preference information (for example, a hobby, an interest part, a favorite haunt, and the like) directly input by the social network members. Further, the social network server 10 may collect the preference information based on information related to use of the electronic apparatus 100 or other electronic apparatus 20 used by the social network members. For example, the social network server 10 may collect the preference information based on information frequently searched by the social network members using the electronic apparatus. On the other hand, the social network members may be users using a specific service of a social network.

In response to a preset command (for example, a user command for selecting a specific icon) being input from the user while the electronic apparatus 100 provides a content, the electronic apparatus 100 determines recommendation subjects for the content provided based on the preference information of the social network members. Specifically, when the preset command is input from the user while the electronic apparatus 100 provides the content, the electronic apparatus 100 may provide to the social network server 10 the preference information of the social network members. In response to the preference information of the social network members being received from the social network server 10, the electronic apparatus 100 may determine the recommendation subjects for the content based on the preference information of the social network members. For example, when the content is football-related content, the electronic apparatus 100 may determine members interested in football as the recommendation subjects based on the preference information of the social network members.

The electronic apparatus 100 may generate a list including the determined recommendation subjects and may display the generated list.

When at least one recommendation subject is selected from the displayed list, the electronic apparatus 100 may recommend the content related to the at least one recommended subject. Specifically, when the at least one recommendation subject is selected from the list, the electronic apparatus 100 may transmit information for the selected at least one recommendation subject and may transmit information for the content to the social network server 10. The social network server 10 may transmit the information for the content to other electronic apparatus 20 used by a recommendation subject to be recommended. The recommendation is to be based on the received information for the recommendation subject to be recommended and the received information for the content.

The other electronic apparatus 20 may display the transmitted information related to the content. In particular, when the other electronic apparatus 20 executes a pre-designated application by the selected recommendation subject, the other electronic apparatus 20 may receive the information related to the content from the social network server 10 and may display the received information on the other electronic apparatus 20.

The user may more efficiently recommend the content more efficiently through the above-described content recommendation system 1 based on the preference information of other members in the social network service.

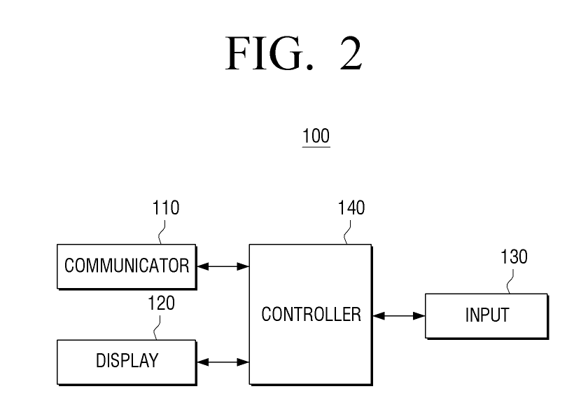

FIG. 2 is a block diagram which illustrates a configuration of an electronic apparatus 100 according to an exemplary embodiment. As illustrated in FIG. 2, the electronic apparatus 100 includes a communicator 110, a display 120, an input 130 and a controller 140.

The communicator 110 is configured to perform communication with an external electronic apparatus or with a server. In particular, the communicator 110 may perform communication with the external social network server 10 to recommend a content to social network members. Further, the communicator 110 may perform direct communication with other electronic apparatus 20 used by the social network member to recommend the content to the social network members.

The display 120 displays image data under the control of controller 140. In particular, the display 120 may display a recommendation subject list to allow the user to select a recommendation subject of the content.

The input 130 receives a user command to control the electronic apparatus 100. In particular, the input 130 may receive the user command for selecting at least one recommendation subject in the recommendation subject list to select a social network member to be recommended by the user.

The controller 140 controls the overall operation of an electronic apparatus 100 according to the user command input through the input 130. In particular, when a preset command (for example, a user command for selecting a specific icon) is input through the input 130 while a specific content (for example, a moving image content, a music content, a web page content, and the like) is provided, the controller 140 may determine recommendation subjects for the content based on preference information of the social network members, and may control the display 120 to display a recommendation subject list for the content. When at least one of the recommendation subjects included in the recommendation subject list is selected through the input 130, the controller 140 may control the communicator 110 to recommend the content to the selected recommendation subject.

Specifically, the user command (for example, user command for selecting a recommendation icon) for content recommendation is input through the input 130, the controller 140 may the request preference information of the social network members to the social network server 10. At this time, the social network server 10 may have previously collected the preference information of the social network members from the other electronic apparatus 20.

In response to the preference information of the social network members being received from the social network server 10 through the communicator 110, the controller 140 may determine the recommendation subjects of the content based on the preference information of the social network members. For example, when the provided content is a music content of a specific genre (for example, hip-hop), the controller 140 may determine members who are interested in the music content of the specific genre, based on the preference information of the social network members as the recommendation subjects.

The controller 140 may control the display 120 to generate a recommendation subject list including the members determined as the recommendation subjects and may display the generated recommendation subject list. At this time, the controller 140 may control display 120 to display the recommendation subject list by aligning the recommendation subjects in the recommendation subject list in descending order according to a degree of interest for the content.

When at least one of the recommendation subjects included in the list is selected through the input 130, the controller 140 may recommend the content for the selected at least one recommendation subject. According to an exemplary embodiment, when the at least one recommendation subject is selected through the list, the controller 140 may control the communicator 110 to transmit information related to the selected recommendation subject and information for the content to the social network server 10, so that the social network server 10 provides the information related to the content to the selected recommendation subject.

According to another exemplary embodiment, in response to the at least one recommendation subject being selected through the list, the controller 140 may control the communicator 110 to transmit the information for the content to the other electronic apparatus 20, which corresponds to the selected recommendation subject, so that the controller 140 may directly transmit the information related to the content to the selected recommendation subject.

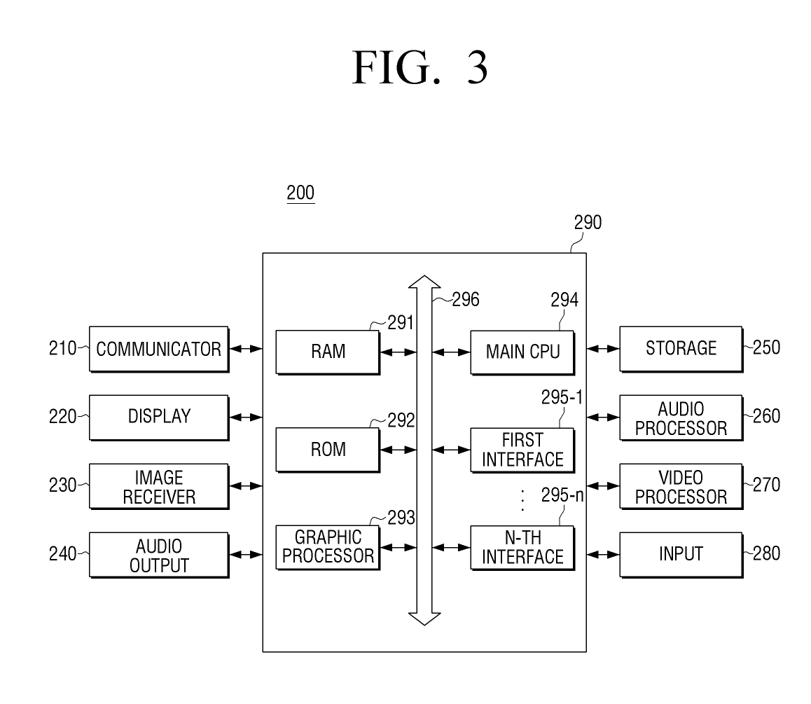

Hereinafter, the electronic apparatus will be described in detail with reference to FIGS. 3 to 6. FIG. 3 is a detailed block diagram which illustrates a configuration of an electronic apparatus 200 according to an exemplary embodiment. As illustrated in FIG. 3, the electronic apparatus 200 includes a communicator 210, a display 220, an image receiver 230, an audio output 240, a storage 250, an audio processor 260, a video processor 270, an input 280, and a controller 290.

FIG. 3 exemplifies that the electronic apparatus 200 includes various functions, such as a content recommendation function, a communication function, a moving image reproduction function, and a display function and integrally illustrates various components. Therefore, in some exemplary embodiments, portions of the components illustrated in FIG. 3 may be omitted or changed, and other components may be added.

The communicator 210 is a configuration configured to perform communication with various kinds of external apparatuses, according to various types of methods of communication. In particular, the communicator 210 may perform communication with the social network server 10 or the other electronic apparatus 20, in order to recommend a content to social network members.

The communicator 210 may include various communication chips such as a wireless fidelity (Wi-Fi) chip, a Bluetooth chip, a near field communication (NFC) chip, and a wireless communication chip. At this time, the Wi-Fi chip, the Bluetooth chip, and the NFC chip perform communication with the Wi-Fi mode, the Bluetooth® mode, and the NFC mode, respectively. The NFC chip among the communication chips means a chip which operates with a NFC mode using a frequency band of 13.56 MHz among various radio frequency identification (RF-ID) frequency bands such as 135 kHz, 13.56 MHz, 433 MHz, 860 to 960 MHz, and 2.45 GHz. In response to the Wi-Fi chip or the Bluetooth® chip is used, the communicator 210 may first transceive various connection information such as a service set identifier (SSID) and a session key, connects communication using the connection information, and transceives a variety of information. The wireless communication chip means a chip which performs communication according to various communication standards such as institute of electrical and electronics engineers (IEEE), Zigbee®, third generation (3G), third generation partnership project (3GPP), and long term evolution (LTE).

The display 220 displays at least one of a video frame, in which image data received from the image receiver 230 is processed through the video processor 270, and various screens generated in a graphic processor 293. In particular, the display 220 may display a recommendation subject list generated by the graphic processor 293.

The image receiver 230 receives image data through various sources. For example, the image receiver 230 may receive broadcast data from an external broadcasting station or may receive the image data from an external apparatus (for example, a digital versatile disc (DVD) apparatus).

The audio output 240 is configured to output various audio data processed in the audio processor 260 and various notifying sounds or messages.

The storage 250 stores various modules configured to drive the electronic apparatus 200. For example, software including a base module, a sensing module, a communication module, a presentation module, a web browser module, and a service module may be stored in the storage 250. At this time, the base module is a basic module configured to process a signal transmitted from respective hardwares included in the electronic apparatus 200 and configured to transmit a processing result to an upper layer module. The sensing module is a module configured to collect information from various sensors, and analyze and manage the collected information. The sensing module may include a face recognition module, a voice recognition module, a motion recognition module, an NFC recognition module, and the like. The presentation module is a module configured to construct a display screen, and may include a multimedia module configured to reproduce and output a multimedia content, and a user interface (UI) rendering module configured to perform UI and graphic processing. The communication module is a module configured to perform communication with the outside. The web browser module is a module configured to perform web browsing to access to a web server. The service module is a module which includes various kinds of applications for providing various services.

As described above, the storage 250 may include various program modules. However, according to a kind and characteristic of the electronic apparatus 200, some of the program modules may be omitted or changed or other program modules may be added. For example, when the electronic apparatus 200 is implemented with a tablet PC, the base module may further include a global positioning system (GSP)-based position determination module configured to determine a position, and the sensing module may further include a sensing module configured to sense an operation of the user.

In particular, the storage 250 may store preference information of social network members received from the social network server 10.

The audio processor 260 is a configuration configured to perform processing on audio data. The audio processor 260 may perform various processing such as decoding, amplifying, or noise filtering on the audio data. The audio data processed in the audio processor 260 may be output to the audio output 240.

The video processor 270 is configured to perform processing on image data received in the image receiver 230. The video processor 270 may perform various image processing such as decoding, scaling, noise filtering, frame rate conversion and resolution conversion on the image data.

The input 280 may receive a user command for controlling an overall operation of the electronic apparatus 200. At this time, the input 280 may be implemented as a remote controller, but it is merely an exemplary embodiment. The input 280 may be implemented with other input devices capable of controlling the electronic apparatus 200, such as a touch panel or a pointing device.

In particular, the input 280 may receive a user command for generating a recommendation subject list to recommend a provided content to social network members. Further, the input 280 may receive the user command for selecting a recommendation subject which is to be a received recommendation for the content from the displayed recommendation subject list.

The controller 290 controls overall operation of the electronic apparatus 200 using various programs stored in the storage 250.

As illustrated in FIG. 3, the controller 290 includes a random access memory (RAM) 291, a read only memory (ROM) 292, the graphic processor 293, a main central processing unit (CPU) 294, a first interface 295-1 to an n-th interface 295-n, and a bus 296. At this time, the RAM 291, the ROM 292, the graphic processor 293, the main CPU 294, and the first to n-th interfaces 295-1 to 295-n may be connected to each other through the bus 296.

A command set for system booting, and the like, is stored in the ROM 292. When a turn-on command is received and power is supplied, the main CPU 294 copies an operating system (O/S) stored in the storage 250 to the RAM 291 according to the command stored in the ROM 292, and executes the O/S to boot the system. When the booting is completed, the main CPU 294 copies to the RAM 291 various application programs stored in the storage 250 and executes the application programs copied to the RAM 291 to perform various operations.

The graphic processor 293 generates a screen including various objects such as an icon, an image, and a text using a calculator (not shown) and a renderer (not shown). The calculator (not shown) calculates an attribute value such as a coordinate value in which each of the objects is to be displayed, a shape, a size, and a color according to a layout of the screen using a control command received from the user command input 280. The renderer generates screens having various layouts, including the objects based on the attribute value calculated in the calculator. The screen generated in the renderer is displayed in a display region of the display 220. In particular, the graphic processor 293 may generate the recommendation subject list.

The main CPU 294 access the storage 250, and perform booting using the O/S stored in the storage 250. The main CPU 294 performs various operations using various programs, contents, data, and the like stored in the storage 250.

The first to n-th interfaces 295-1 to 295-n are connected to the above-described components. One of the interfaces may be a network interface connected to an external apparatus through a network.

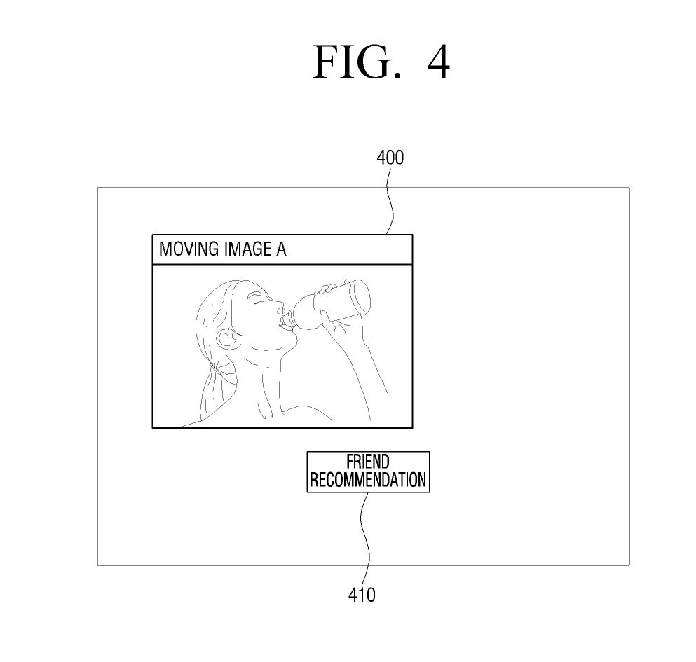

Specifically, the controller 290 may be configured to control the display 220 or the audio output 240 to provide a content. For example, the controller 290 may control the display 220 to provide a moving image content 400 as illustrated in FIG. 4. However, the moving image content 400 illustrated in FIG. 4 is merely an exemplary embodiment, and various contents such as a music content, a web page content, an application content, and a shopping content may be provided.

When a preset user command is input through the input 280 while the content is provided, the controller 290 may determine recommendation subjects of the provided content based on preference information of social network members. Specifically, when a friend recommendation icon 410 illustrated in FIG. 4 is selected through the input 280, the controller 290 may request the preference information of the social network members to the social network server 10. In response to the request, when the social network server 10 transmits the pre-stored preference information of the social network members to the electronic apparatus 100, the controller 290 may determine the recommendation subjects based on the received preference information of the social network members. For example, in response to the content being a football-related moving image content, the controller 290 may determine the recommendation subjects who are interested in football, based on the received preference information of the social network members. That is, the controller 290 may determine a social network member who inputs an interest in “football,” who frequently visits a “football”-related web page, or who frequently searches “football”-related information, based on the preference information of the social network members, as the recommendation subject interested in football.

The above-described embodiment has described that the preference information of the social network member is received from the social network server 10, but this is merely an exemplary embodiment and the electronic apparatus 200 may directly receive the preference information from the other electronic apparatus 20 and may pre-store the received preference information in the storage 250.

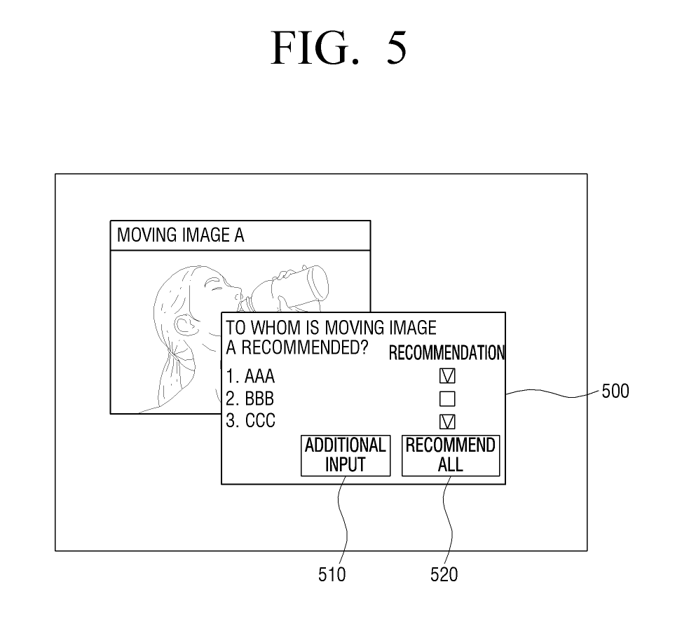

When the recommendation subjects are determined, the controller 290 may be configured to control the display 220 to generate a recommendation subject list including the determined recommendation subjects, and may display the generated recommendation subject list. For example, the controller 290 may control display 220 to display a recommendation subject list 500 as illustrated in FIG. 5. At this time, the recommendation subject list 500 may include an “additional input icon” 510 for selecting a social network member not included in the list as the recommendation subject, and a “recommend all icon” 520 for selecting all recommendation subjects included in the list. Specifically, when a member, not included in the list, is individually input through the “additional input icon” 510, the controller 290 may recommend a content to the input member. Further, when the “recommend all icon” 520 is selected, the controller 290 may recommend the content to all recommendation subjects included in the list. Further, the controller 290 may be configured to control the display 220 to display the list by aligning the recommendation subjects of the list in descending order of a degree of interest for the content. At this time, the degree of interest for the content may be determined through whether or not the user directly inputs an interest part, the number of searches for the content-related field, the number of visits to a web page for the content-related field, and the like.

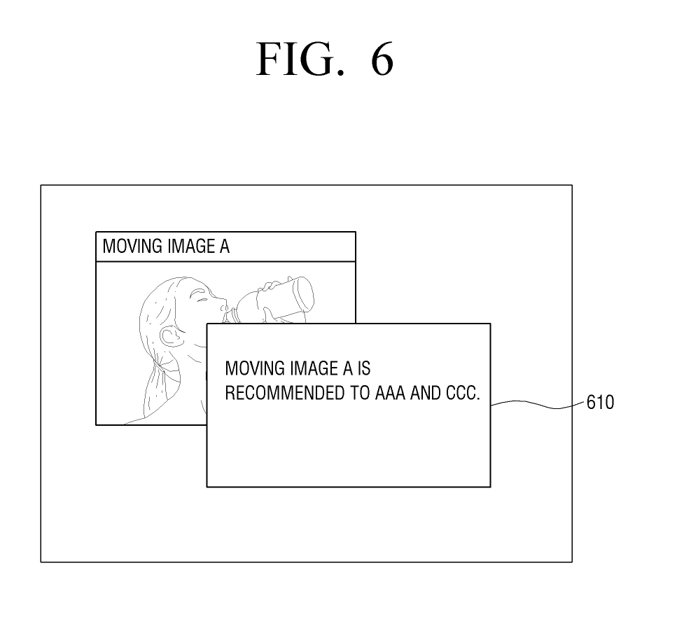

When the at least one recommendation subject is selected through the list, the controller 290 recommends the content to the selected for the at least one recommendation subject. Specifically, when “AAA” and “CCC” are selected through the list 500 illustrated in FIG. 5, the controller 290 may control the communicator 210 to transmit information for the selected “AAA” and “CCC” and information for a currently provided content, to the social network server 10. The controller 290 may control the display 220 to display a user interface (UI) 610 including a recommendation result message as illustrated in FIG. 6.

According to the above-described exemplary embodiment the electronic apparatus 200 transmits to the social network server 10 the information for the selected recommendation subject and the information for the currently provided content but this is merely an exemplary embodiment. The electronic apparatus 200 may directly transmit the information for the currently provided content to the other electronic apparatus 20, which corresponds to the selected recommendation subject.

By the above-described electronic apparatuses 100 and 200, the user may recommend the content by considering the preference information of the social network members.

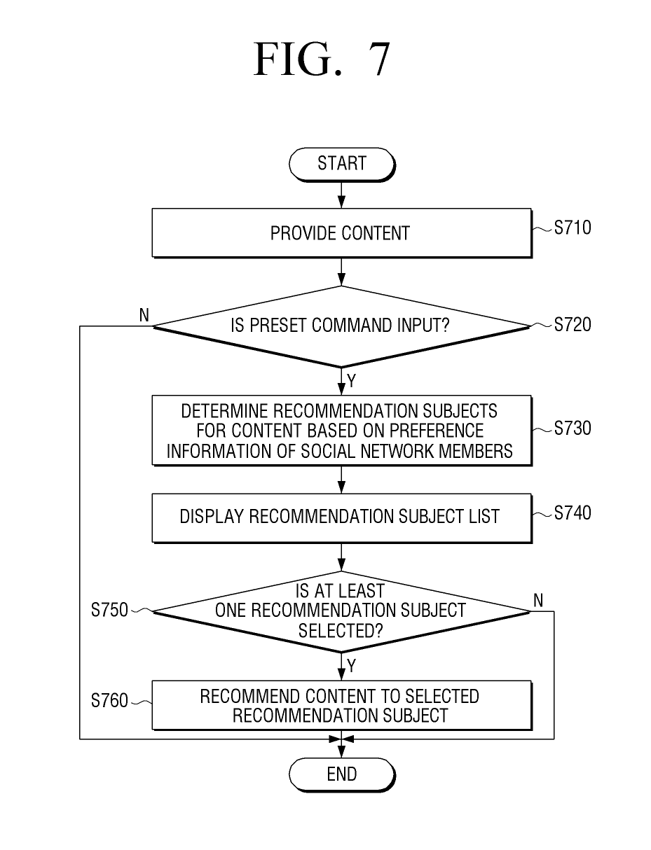

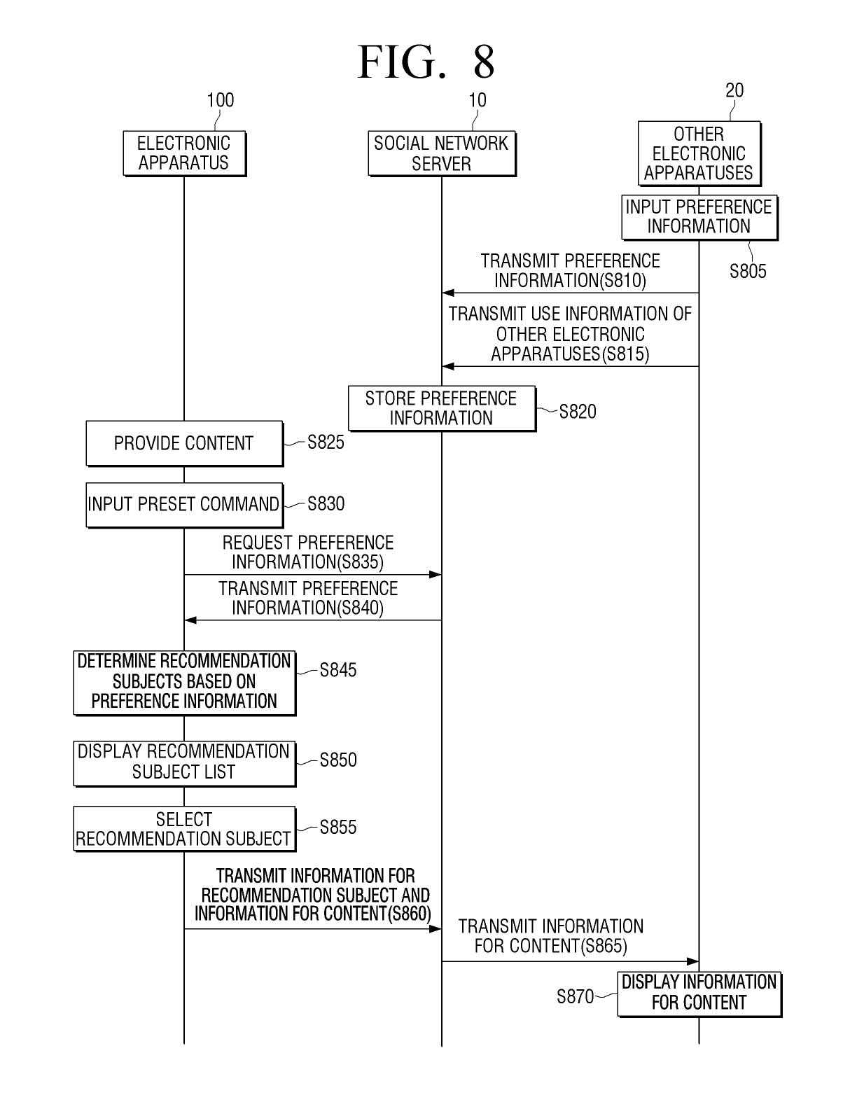

Hereinafter, a method of recommending content will be described with reference to FIGS. 7 and 8.

FIG. 7 is a flowchart which illustrates a method of recommending content method of the electronic apparatus 100, according to an exemplary embodiment.

The electronic apparatus 100 provides a content (S710). At this time, as the content, various contents such as a moving image content, a photo content, a music content and a web page content may be provided.

While the content is provided, the electronic apparatus 100 determines whether or not a preset commend is input (S720). At this time, the preset command may be a user command for selecting a recommendation icon. However, this is merely an exemplary embodiment, and the preset command may include a voice command, a motion command for content recommendation, etc.

When the preset command is input (S720-Y), the electronic apparatus 100 determines recommendation subjects based on the preference information of social network members (S730). At this time, the electronic apparatus 100 may receive the preference information of the social network members from the social network server 10 or from the other electronic apparatus 20.

The electronic apparatus 100 displays a recommendation subject list including the recommendation subjects (S740).

The electronic apparatus 100 determines whether or not at least one from among the recommendation subjects included in the list is selected (S750).

When the at least one recommendation subject is selected (S750-Y), the electronic apparatus 100 recommends a content for the selected recommendation subject (S760). Specifically, to recommend to the content to selected recommendation subject, the electronic apparatus 100 may transmit information related to selected recommendation subject and information for the content to the social network server 10. Alternatively, the electronic apparatus 100 may transmit the information for the content to the other electronic apparatus 20 which corresponds to the selected recommendation subject.

FIG. 8 is a sequence diagram which illustrates a method of recommending content of a content recommendation system 10, according to an exemplary embodiment.

First, other electronic apparatuses 20 receive preference information from social network members (S805). The other electronic apparatuses 20 transmit the preference information to the social network server 10 (S810). Further, the other electronic apparatuses 20 transmit usage information of the other electronic apparatuses to the social network server 10 (S815).

The social network server 10 stores the preference information based on the preference information received from the other electronic apparatuses 20 (S820). Specifically, the social network server 10 may store the preference information received from the other electronic apparatuses 20 or may analyze and store the preference information based on the apparatus use information received from the other electronic apparatuses 20.

The electronic apparatus 100 provides a content (S825). Specifically, the electronic apparatus 100 may provide at least one content selected from the group consisting of a moving image content, a photo content, a music content, and a web page content.

The electronic apparatus 100 receives a preset user command (S830). For example, the electronic apparatus 100 may receive the user command for selecting a recommendation icon.

The electronic apparatus 100 requests from the social network server 10 (S835) the preference information of the social network members. The social network server 10 transmits the preference information of the social network members in response to the request for the preference information (S840).

The electronic apparatus 100 determines recommendation subjects based on the preference information received from the social network server 10 (S845). The electronic apparatus 100 displays a recommendation subject list including the determined recommendation subjects (S850).

The electronic apparatus 100 selects a recommendation subject in response to a user input through the recommendation subject list (S855).

In response to the recommendation subject being selected, the electronic apparatus 100 transmits to the social network server 10 (S860) information related to the selected recommendation subject and information related to the content.

The social network server 10 transmits the information related to the content to the other electronic apparatuses 20 (S865). Specifically, the social network server 10 may determine other electronic apparatus 20 which corresponds to the selected recommendation subject based on the information for the selected recommendation subject, and may transmit to the determined electronic apparatuses 20 the information related to the content.

The other electronic apparatuses 20 displays received content information (S870). At this time, the other electronic apparatuses 20 may display information related to a content recommended by the other user when a preset application (for example, a corresponding social network service application) is executed.

As described above, since the recommendation subject is selected based on the preference information of the social network members, the user may effectively recommend the currently provided content to other social network members.

The above-described exemplary embodiment has been described to recommend the content, but this is merely an exemplary embodiment. The inventive concept may be also applied to a method of recommending other information (for example, shopping articles, news articles, and the like).

The content recommendation method of the electronic apparatus according to the above-described exemplary embodiments may be implemented with a program and may be provided to electronic apparatuses.

Specifically, a non-transitory computer-readable storage medium, in which the program, including determining recommendation subjects related to a content based on preference information of social network members when a preset command is received while the content is provided; displaying a list, including the recommendation subjects for the content, and recommending the content to a selected recommendation subject when at least one of the recommendation subjects included in the list is selected, is stored, may also be provided.

The non-transitory computer-recordable storage medium is not a medium configured to temporarily store data such as a register, a cache, a memory, and the like, but rather is an apparatus-readable medium configured to semi-permanently store data. Specifically, the above-described applications or programs may be stored and provided in the non-transitory computer-recordable medium such as a compact disc (CD), a DVD, a hard disc (HD), a Blu-ray Disc™, a universal serial bus (USB), a memory card, a ROM, and the like.

The foregoing exemplary embodiments and advantages are merely exemplary and are not to be construed as limiting the present invention. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A method of recommending a content for an electronic apparatus, the method comprising:
determining recommendation subjects for a content based on preference information of social network members in response to a preset command being input while the content is provided;
displaying a list which includes the recommendation subjects of the content; and
recommending the content related to a selected recommendation subject in response to at least one of the recommendation subjects included in the list being selected.

2. The method as claimed in claim 1, wherein the determining includes:
requesting the preference information of the social network members from a social network server; and
determining the recommendation subjects for the extracted content based on the preference information of the social network members in response to the preference information of the social network members being received from the social network server.

3. The method as claimed in claim 2, wherein the recommending of the content includes transmitting information for the selected recommendation subject and information related to the content to the social network server so that the social network server provides the information related to the content for the selected recommendation subject.

4. The method as claimed in claim 2, wherein the preference information of the social network members is directly input by the social network members or determined by the social network server based on apparatus usage information of the social network members which is stored in the social network server.

5. The method as claimed in claim 2, wherein the social network server provides the information for the content related to the selected recommendation subject in response to a pre-designated application being executed by the selected recommendation subject.

6. The method as claimed in claim 1, wherein the displaying includes displaying the list by aligning the recommendation subjects of the list in descending order of a degree of interest in the content.

7. The method as claimed in claim 1, further comprising recommending the content to an input member in response to the member who is not included in the list being individually input.

8. The method as claimed in claim 1, wherein the recommending includes recommending the content related to all the recommendation subjects included in the displayed list in response to a specific icon included in the list being selected.

9. An electronic apparatus, comprising:
a communicator configured to perform communication with an external apparatus;
an input configured to receive a user command;
a display; and
a controller configured to determine recommendation subjects for a content based on preference information of social network members in response to a preset command being input while the content is being provided, control the display in order to display a list which includes the recommendation subjects related to the content, and control the communicator to recommend the content related to a selected recommendation subject in response to at least one of the recommendation subjects included in the list being selected through the input.

10. The electronic apparatus as claimed in claim 9, wherein the communicator is configured to perform communication with a server of a social network,
wherein the controller requests the preference information of the social network members from the social network server, and determines the recommendation subjects for the content extracted based on the preference information of the social network members in response to the preference information of the social network members being received through the communicator from the social network server.

11. The electronic apparatus as claimed in claim 10, wherein the controller is configured to control the communicator to transmit to the social network server information related to the selected recommendation subject and information related to the content so that the social network server provides to the selected recommendation subject the information related to the content.

12. The electronic apparatus as claimed in claim 10, wherein the preference information of the social network members is directly input by the social network members or is determined by the social network server based on apparatus usage information of the social network members which is stored in the social network server.

13. The electronic apparatus as claimed in claim 10, wherein the social network server provides the information related to the content for the selected recommendation subject in response to a pre-designated application being executed by the selected recommendation subject.

14. The electronic apparatus as claimed in claim 9, wherein the controller controls the display in order to display the displayed list by aligning the recommendation subjects of the list in descending order of a degree of interest for the content.

15. The electronic apparatus as claimed in claim 9, wherein the controller is configured to control the communicator to recommend the content to an input member in response to social network member who is not included in the list being individually input through the input.

16. The electronic apparatus as claimed in claim 9, wherein the controller is configured to control the communicator in order to recommend the content related to all the recommendation subjects included in the displayed list in response to a specific icon included in the list being selected through the input.

17. An electronic apparatus, comprising:
a communicator configured to perform communication with an external apparatus; and
a controller configured to determine recommendation subjects for a content based on preference information of social network members, control a display in order to display a list which includes the recommendation subjects related to the content, and control a communicator to recommend the content related to a selected recommendation subject.

18. The electronic apparatus of claim 17, further comprising an input configured to receive a user command.

19. The electronic apparatus of claim 17, further comprising a display.

20. The electronic apparatus of claim 17, wherein the controller determines recommendation subjects for a content in response to a preset command being input while the content is being provided.

21. The electronic apparatus of claim 18, wherein the controller controls the communicator to recommend the content in response to at least one of the recommendation subjects included in the list being selected through the input.

22. The electronic apparatus as claimed in claim 21, wherein the communicator is configured to perform communication with a server of a social network,
wherein the controller requests the preference information of the social network members from the social network server, and determines the recommendation subjects for the content extracted based on the preference information of the social network members in response to the preference information of the social network members being received through the communicator from the social network server.

23. The electronic apparatus as claimed in claim 22, wherein the controller is configured to control the communicator to transmit to the social network server information related to the selected recommendation subject and information related to the content so that the social network server provides to the selected recommendation subject the information related to the content.
